(19) United States
(12) Patent Application Publication
(10) Pub. No.: US 2007/0059511 A1
(43) Pub. Date: Mar. 15, 2007

(54) Low density foamed polymers

(76) Inventors: Walter L. Edwards, Harrisburg, NC (US); Frederick L. Travelute III, Charlotte, NC (US); Glen P. Reese, Charlotte, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/364,242

(22) Filed: Feb. 28, 2006

Related U.S. Application Data
(63) Continuation-in-part of application No. 10/813,893, filed on Mar. 31, 2004.
(60) Provisional application No. 60/657,236, filed on Feb. 28, 2005.
(60) Provisional application No. 60/724,061, filed on Oct. 5, 2005.

(51) Int. Cl. B32B 3/26

(52) U.S. Cl. 428/304.4

(57) ABSTRACT

A foamed polymer melt including a thermoplastic polymer or polymer blend; a nucleating agent present in an amount sufficient to form a large number of very small cells, specifically cells having a diameter of no greater than about 150 μm, and chemically inert with respect to the thermoplastic polymer or polymer blend; and a blowing agent present in an amount sufficient to effectuate foaming but less than an amount that would plasticize the polymer composition, and inert with respect to the thermoplastic polymer or polymer blend and the nucleating agent is provided.

This application is a continuation in part of Ser. No. 10/813,893 filed Mar. 31, 2004. This application also claims priority from Ser. No. 60/657,236 filed Feb. 28, 2005 and Ser. No. 60/724,061 filed Oct. 5, 2005. The present invention relates to foamed polymers. The use of foamed polymers for many purposes is generally well established and well understood. As exemplary, but certainly not limiting, possibilities, foamed polymers are used for packaging, for thermal insulation in a variety of areas including food handling and residential and commercial construction, for sound insulation, for electrical insulation, and for resilient cushioning purposes such as furniture.

### BACKGROUND

As working materials, foamed polymers offer the advantages of polymers including wide availability, generally well understood chemistry, and in many cases relatively low cost. Many polymers, including polyesters, exhibit excellent mechanical, electrical, and chemical-resistance properties, weather resistance, and are superior in tensile strength.

Foamed materials offer their own set of physical and structural advantages, including low density; sound, thermal, and electrical insulation; improved stiffness; and cushioning properties as noted above.

Polyesters offer other advantages over other polymer products. For example, in certain applications, polyester is advantageous because of its optical clarity and transparency. In other applications (for example computer technology and photography), opacity is a desired property and thus polyester's transparency and high relative density become drawbacks. For such applications, polyester (if used) must be rendered opaque by using large amounts of white pigments. Such loading can, of course, adversely affect other desired properties of the polymer. Foaming of polyester itself renders the polyester opaque, eliminating the need for adding pigments.

For a number of applications, foams with smaller cell sizes are preferred. Small cells, as opposed to larger cells, will not as easily propagate defects or cracks in the foam structure. Small cells tend to improve strength properties such as impact strength and compression strength relative to larger-celled foams at the same foam density in addition to improved insulation properties. As another advantage, thinner foam substrates can be produced using smaller cell sizes. Small cells can increase the bulk strength of the resulting foam while increasing its void fraction (thus reducing its density). Smaller cells are typically more uniform in size leading to improved mechanical and thermal properties.

Foamed polymers are typically formed in one of a few basic techniques, but with almost unlimited permutations, and a foam's properties will tend to reflect both the underlying composition of the polymer and the techniques that formed it. Those skilled in the art will recognize a number of these general and specific techniques and their results.

One technique incorporates chemical precursors that react when mixed to produce both a liquid polymer that will solidify reasonably quickly (e.g. 1-2 minutes) at about room temperature along with gaseous byproducts. In such techniques, the gaseous byproducts bubble through the polymer as it solidifies to produce the resulting foam. Exemplary reactions include those between isocyanates and polyalcohols (“polyols”) which produce carbon dioxide and water vapor while concurrently forming polyurethane. Such foaming reactions have gained wide acceptance in certain fields (e.g., foam-in-place packaging), but the viscosity and related properties of such foams make them less suitable for certain other applications, and they tend to be limited to compositions that perform in the intended manner under the desired conditions.

In another technique, a gas (often referred to as a “physical blowing agent”) is dissolved in the melt for the purpose of escaping and forming cells when the melt conditions (typically a drop in pressure) are changed. In such techniques, the rate at which the gas escapes must complement the rate at which the polymer solidifies.

In yet other techniques, a solid material (referred to as a “chemical blowing agent”) is included in the polymer or its precursors and is intended to decompose to form gases under certain conditions. Such solid agents can be difficult to control, however, with resulting difficulties in adjusting the void percentage, the uniformity of cells and their size. Chemical blowing agents are typically not capable of producing low density foams. Additionally, some of these decomposition-type blowing agents can undesirably modify the resulting polymer or add undesirable coloration to the resulting polymer.

Problems exist in the formation of foam by any one or more of these methods or combinations of methods. For example, in some cases the amount of blowing agent required to provide the foam with certain of its qualities (e.g., insulating performance) causes a corresponding decrease in dimensional stability.

In some polymer and blowing agent systems, consistent and elevated levels of open cell content tend to be difficult to produce unless relatively high foaming temperatures are used. In turn, these high foaming temperatures can cause the foam to collapse resulting in a higher density product (foams are favored for lower density) and smaller cross-sections.

Alternatively, if the vapor pressure of the blowing agent is too high, the growth rate of the foam can exceed the melt strength of the polymer, resulting in a complete collapse of the foam.

As another problem, blowing agents that successfully form large numbers of cells can also create irregular or rough surfaces on the resulting foam.

Other techniques and compositions suffer from undesired shrinkage in the resulting foam due to cell collapse.

Other blowing agents are more chemically reactive than would be otherwise desired (for example they tend to be acidic) and thus can cause chemical decomposition problems in the foam or even react unfavorably with materials or items that are brought in contact with the foam. In such cases, chemical scavengers are sometimes added to the foam precursor to address the problems created by the blowing agent. The scavenger, however, adds another level of complexity and practical limits will typically limit the amount of scavenger that can be used before it interferes with the other properties of the desired foam or blowing agent.

Other blowing agents are flammable (e.g. propane, butane, pentane, heptane) while yet others have solubility problems that prevent them from making useful foams.

As another problem, environmental concerns, safety regulations, or market demand may preclude the use of certain blowing agents, or their eventual release from a finished foam. Alternatively, the presence of certain residual blowing agents in the foam can likewise be undesirable or raise regulatory issues.

Accordingly, and in spite of the wide use and acceptance of foamed polymers, a need continues to exist for improvements in this art.

### SUMMARY OF THE INVENTION

In one embodiment, the invention is a foamed polymer melt including a thermoplastic polymer; a nucleating agent present in an amount sufficient to form a large number of very small cells, specifically cells having a diameter of no greater than about 150 μm, and chemically inert with respect to the thermoplastic polymer; and a blowing agent present in an amount sufficient to generate foam but less than an amount that would excessively plasticize the polymer composition, and inert with respect to the thermoplastic polymer and the nucleating agent.

In another embodiment, the invention is a method of forming a foamed polymer. The method includes extruding a molten thermoplastic polymer containing an inert nucleating agent at or above the melt temperature of the thermoplastic polymer, and injecting a blowing agent into the extruded melt.

In yet another embodiment, the invention is a method of forming a foamed thermoplastic polymer. The method includes extruding a molten thermoplastic polymer in the presence of a blowing agent and nano-sized fluorocarbon particles.

In yet another embodiment, the method includes extruding a molten thermoplastic polymer blend in the present of a blowing agent and micro-sized fluorocarbon particles.

In another aspect, the invention is a copolymer melt composition. In this aspect, the composition includes at least about 80 percent by weight of a thermoplastic resin; a nucleating agent formed of particles with their largest dimension no more than about 900 nanometers, present in an amount of between about 0.1 and 10 percent by weight of the composition, and chemically inert with respect to the thermoplastic resin, and a blowing agent that is chemically inert with respect to the nucleating agent and thermoplastic resin being present in an amount of no more than about 10% by weight of the composition.

In another aspect, the invention is a thermoplastic polymer blend melt composition. In this aspect, the composition includes at least about 80 percent by weight of a thermoplastic polymer blend, a nucleating agent composition formed of particles wherein about 90% of the particles have a particle size of less than about 20 μm, present in an amount of between about 0.1 and 10 percent by weight of the composition, and chemically inert with respect to the thermoplastic polymer blend, and a blowing agent that is chemically inert with respect to the nucleating agent composition and being present in an amount of no more than about 10% by weight of the composition.

In another aspect, the invention is a method of forming a polymer that favorably forms foamed shaped items. The method includes extruding a composition of a thermoplastic resin, a nucleating agent in an amount of between about 0.1 and 10 percent by weight of the composition and being insoluble and chemically inert with respect to the thermoplastic resin, and a blowing agent in an amount of no more than about 10% by weight, the blowing agent being soluble in the thermoplastic resin, chemically inert with respect to the thermoplastic polymer and the nucleating agent, and normally in the gaseous state at atmospheric pressure; while carrying out the extrusion at a pressure drop sufficient to form cells on individual particles of the nucleating agent as the composition extrudes, and thereafter quenching the extruded foamed melt composition into a solid.

In yet another aspect, the invention comprises a foamable thermoplastic resin melt that includes a thermoplastic polymer, a nucleating agent with a diameter, as measured at the largest dimension of no more than about 900 nm and chemically inert with respect to the thermoplastic polymer, and a blowing agent that is chemically inert with respect to the thermoplastic polymer and nucleating agent and normally in the gaseous state at atmospheric pressure.

In yet another aspect, the invention comprises a foamable thermoplastic resin melt that includes a thermoplastic polymer blend, a nucleating agent with a largest dimension of no more than about 20 μm and chemically inert with respect to the thermoplastic polymer blend, and a blowing agent that is chemically inert with respect to the thermoplastic polymer blend and nucleating agent and normally in the gaseous state at atmospheric pressure.

### BRIEF DESCRIPTION OF THE DRAWINGS

FIGS. 1A, 1B, 2A, 2B, 3A, 3B, 4A, 4B, 5A, 5B, 6A, and 6B are Scanning Electron Microscopy (SEM) pictures of PTFE nanoparticles contemplated as useful in the present invention.

FIGS. 7, 8, 9, 10, 11, and 12 are SEM pictures of PTFE nanoparticles demonstrating an altered morphology in a thermoplastic extrudate in accordance with the present invention.

### DETAILED DESCRIPTION

In one aspect, the present invention is a foamed thermoplastic polymer composition including a thermoplastic polymer resin, nucleating particles, and a blowing agent.

The term “thermoplastic polymer” is used herein in its broadest sense, which is typically, although not necessarily exclusively, as defined in Hawley's Condensed Chemical Dictionary, Eleventh Edition, as a polymer that softens when exposed to heat and returns to its original condition when cooled to room temperature. The term polyester, as used herein, is any long-chain synthetic polymer composed of at least 85% by weight of an ester of a substituted aromatic carboxylic acid, including, but not restricted to, substituted terephthalic units, p(-R—O—CO—C6H4-CO—O-)x and parasubstituted hydroxyl benzoate units, p(-R—O—CO—C6H4-O-)x. Another conventional definition refers to polyester as the condensation product of a dicarboxylic acid (or its equivalent ester) and a poly alcohol (polyol).

In one embodiment, the thermoplastic polymer composition includes a thermoplastic polymer blend (i.e., mixture) of at least one thermoplastic polymer and one additional component. For example, additional components that may be blended with the at least one thermoplastic polymer may include one or more of homopolymers, copolymers, comonomers, and plasticizers. In an exemplary embodiment, a polyethylene terephthalate may be blended with an additional homopolymer, copolymer, comonomer, plasticizer, and combinations thereof. It may be preferred to blend a thermoplastic polymer with between about two and ten percent of one or more of the additional homopolymer, conomoner, copolymer, and plasticizer.

Without being bound by theory, it appears that the use of a polymer blend increases the free volume of the polymer composition. As is known to persons having ordinary skill in the art, polyester is a linear polymer that packs closely together. Blending a second component (such as those discussed above) into a polyester composition may serve to increase the free volume of the composition, thereby increasing the extensibility and elasticity of the polyester. This increase in extensibility and elasticity of the polymer composition increases the relaxation time of the polymers, thereby aiding in the formation of the present foamed polymers.

As known by persons having ordinary skill in the art, a blend of polymers can be distinguished from a homopolymer or random and block copolymers based upon observed glass transition temperatures (Tg) and melt points. For example, in most circumstances a random copolymer will have a single Tg and a single melt point. A block copolymer will have more than one Tg or melt point depending upon the nature of the block composition. By comparison, a polymer blend can have distinct Tg's and melt points for each component depending upon the degree of compatibilization between the components.

For ease of description, unless explicitly stated otherwise, the invention will be described with reference to thermoplastic resins. It will be understood, however, that the thermoplastic polymer blends are contemplated throughout the application.

In a preferred embodiment, the foamed thermoplastic polymer composition comprises greater than about 80% by weight, more preferably greater than about 85% by weight, and most preferably greater than about 90% by weight thermoplastic polymer or thermoplastic polymer blend. The thermoplastic polymer included in the composition may be a single polymer or may be a combination of thermoplastic polymers.

In preferred embodiments, the thermoplastic resins can include or be selected from among polyesters, aliphatic polyesters, polylactides (i.e. polylactic acid), polyamides, polycarbonates, polyolefins, polyacrylics, polystyrenes, styrenic copolymers (ABS) and polyvinylchloride.

Thermoplastic polyesters contemplated as useful include those having diacid or dimethyl ester components independently chosen from terephthalic acid, isophthalic acid, naphthalenedicarboxylic acid, phthalic acid or phthalic anhydride, cyclohexanedicarboxylic acid, biphenyl dicarboxylic acid, any of the series of C4-C10 aliphatic dicarboxylic acids or a spiroacetal compound of general formulae: 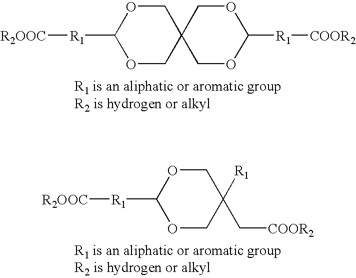
and combinations thereof.

Thermoplastic polyesters contemplated as useful also contain diol components. Diol components are preferably independently chosen from ethylene glycol, diethylene glycol, 1,2-cyclohexanedimethanol, 1,3-cyclohexanedimethanol, 1,4-cyclohexanedimethanol, 1,3-propanediol, 2-methyl-1,3-propanediol, 1,4-butanediol, neopentyl glycol, 1,6-hexanediol, isosorbide, a spiro acetal compound of general formulae 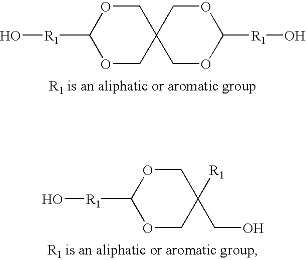
polyalkylene oxides selected from polyethylene oxide (PEO), polypropylene oxide (PPO), ethylene oxide-propylene oxide (EO/PO) copolymers and polytetramethylene glycol (PTMG) and combinations thereof. These polyalkylene oxides can vary in molecular weight as represented below:

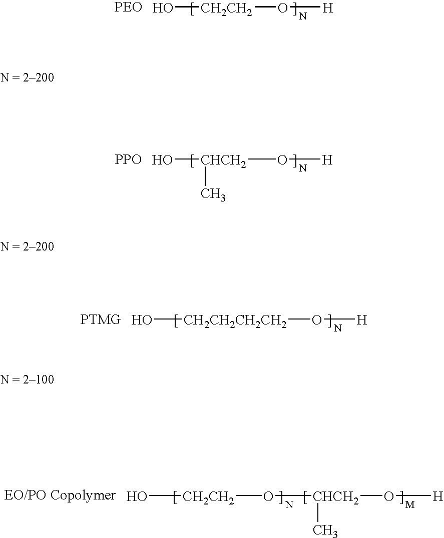

Also contemplated as useful in the present invention are terminally-functionalized siloxane polymers or copolymers of general formula: 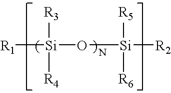
where R₁ and R₂ are independently selected from alkyl, phenyl, hydroxyalkyl, aminoalkyl, alkoxy, polyether, polyether alcohol and polyether amine; R₃—R₆ are independently selected from alkyl or phenyl groups or combinations thereof.

In a preferred embodiment, the thermoplastic resins, particularly the polyester resins, can be unbranched. Foaming of the resins is achieved according to the method of the invention, without requiring branching in the thermoplastic polymer backbone.

Preferred thermoplastic resins may optionally contain monomeric branching agents to improve melt strength and melt viscoelasticity of the thermoplastic resins such as pentaerythritol, trimethylolpropane, glycerol, trimellitic anhydride (TMA), pyromellitic anhydride (PMDA), organic anhydrides, epoxides, isocyanates, and combinations thereof. Especially preferred branching agents include 3,3′,4,4′-biphenyl tetracarboxylic dianhydride, benzophenone tetracarboxylic dianhydride, diphenylsulfone tetracarboxylic dianhydride, pyromellitic dianhydride, trimellitic acid, pyromellitic acid, cyclopentane tetracarboxylic dianhydride, tetrahydrofuran tetracarboxylic dianhydride, 1,1,4,4-tetrakis(hydroxymethyl) cyclohexane, hydroxyterephthalic acid, dimethyl hydroxyl terephthalate, dihydroxybenzoic acid, 1,2,2-ethanetricarboxylic acid, triglycidyl isocyanurate, and combinations thereof.

Preferred thermoplastic resins may also optionally include polymeric branching agents known in the art. Preferred polymeric branching agents include copolymers of ethylene or α-olefins with acrylic acid, vinyl acetate, an alkyl acrylate, vinyl alcohol, alkyl methacrylate, maleic anhydride, glycidyl methacrylate, and combinations thereof. Especially preferred polymeric branching agents include poly(ethylene-8% acrylic acid), poly(ethylene-4% vinyl acetate), poly(ethylene-8% alkyl acrylate), poly(ethylene-56% vinyl alcohol), poly(ethylene-15% methacrylic acid, Na salt), poly(ethylene-15% alkyl methacrylate), and combinations thereof.

In the case of polyolefins or polystyrenics, pendant side groups or chain branching may be desired for improved melt strength (e.g., low density polyethylene, linear low density polyethylene, and polypropylene). Irradiation treatment of polyolefins can also be used to create cross-linked polymer chains to improve melt strength. Pendant chlorine groups as those found in polyvinyl chloride or pendant phenyl rings such as those found in polystyrene contribute to melt strength.

The nucleating agent is selected to be chemically inert with respect to the melt composition and with respect to the blowing agent. Thus, any composition whose chemical reaction with any of the other elements is minimal, or for practical purposes nonexistent, is suitable, with fluorinated hydrocarbons generally being an exemplary example and polytetrafluoro-ethylene (PTFE) being a more specific exemplary embodiment. The nucleating agent also preferably has a low surface energy, i.e., the particles are not very wettable with respect to the thermoplastic polymers.

As is known to persons having ordinary skill in the art, particles of polytetrafluoroethylene (PTFE) are often prepared by one of two methods. One method includes polymerizing PTFE to low molecular weights, then grinding the low molecular weight PTFE into smaller particles. Another method involves irradiating high molecular weight PTFE with an electron beam to break polymer bonds thereby fragmenting the polymer into smaller segments to lower the molecular weight. The irradiated PTFE can then be ground into small particles. PTFE particles formed according to the irradiation method often include acid groups on the surface of the particles, because the irradiation step is most often conducted in ambient air, resulting in oxidation of the particle surface.

Without being bound by theory, it appears that the presence of acid groups on the surface of the PTFE particles results in higher relative surface energy than non-irradiated PTFE. The higher surface energy particles appear to have a higher “wettability” in the polymer (homopolymer, copolymer, or blend) than the particles formed by grinding low molecular weight PTFE because the polar acid groups on the surface of the irradiated particles may interact with the polymer composition. Accordingly, it appears that non-irradiated particles perform better than irradiated PTFE particles because of the non-irradiated particles' lower surface energy and lower wettability.

These two methods of preparing PTFE particles also tend to produce a range of particle sizes (as measured by diameter of the individual particles). In exemplary embodiments, preferred nucleating agent particles are individual particles, rather than agglomerations of smaller particles. More particularly, exemplary PTFE compositions have a particle size distribution wherein about 90% of the particles have a diameter of less than about 20 μm. Stated differently, exemplary PTFE compositions include 80% of particles having a diameter between about 3 and 20 μm.

Exemplary nucleating agents are perfluorocarbon microparticles. Polytetrafluoroethylene (PTFE) is a widely available and well understood fluorinated hydrocarbon that is suitable and preferred as the nucleating agent and is available under a number of trade names, perhaps the most widely known of which is DuPont TEFLON®. Commercially available perfluorocarbon microparticles include NANOFLON® P51A and FLUOROFG® (Shamrock Technologies, Inc.); DYNEON® PA5951 and PA5955 (Dyneon, LLC); TEFLON®, and ZONYL® MP1400, MP1500, and MP1600 (E.I. DuPont de Nemours and Co.).

Tables 1 and 2 summarize various commercially available PTFE particle compositions. Table 1 sets forth the general information regarding the particle compositions as provided by the various manufacturers. Table 2 sets forth the particle size distribution of the PTFE compositions described in Table 1 as determined by laser light scattering after dispersion in a light mineral oil and sonication to break up large agglomerates prior to analysis.

TABLE 1

| | | | Surface Area | Avg. Diameter |
|---|---|---|---|---|
| Tradename | Vendor | Processing | (BET, m²/g) | (microns) |
| Nanoflon P51A | Shamrock | irradiated | 8.7 | 13.3 |
| | Technologies | | | |
| Nanoflon | Shamrock | irradiated | 9.9 | 8.3 |
| FluoroFG | Technologies | | | |
| PA5951 | Dyneon, | not | 10 | 10.6 |
| | LLC | irradiated | | |
| PA5955 | Dyneon, | not | 17 | 9.6 |
| | LLC | irradiated | | |
| Zonyl MP1400 | DuPont | irradiated | 4.5 | 9.3 |
| Zonyl MP1600 | DuPont | not | 10 | 8.6 |
| | | irradiated | | |

TABLE 2

| | Particle Diameter (microns) | | | | | |
|---|---|---|---|---|---|---|
| PTFE ID: | MP1400 | MP1600 | PA5951 | PA5955 | FluoroFG | P51A |
| Avg. | 9.3 | 8.6 | 10.6 | 9.6 | 8.3 | 13.3 |
| by | | | | | | |
| wt/vol): | | | | | | |
| 10% | 3.2 | 3.8 | 5.0 | 4.2 | 2.4 | 4.0 |
| less than: | | | | | | |
| 50% | 8.1 | 7.7 | 9.6 | 8.6 | 6.6 | 11.8 |
| less than: | | | | | | |
| 90% | 16.6 | 14.9 | 17.7 | 16.5 | 15.4 | 24.9 |
| less than: | | | | | | |
| Breadth of | 1.67 | 1.45 | 1.32 | 1.43 | 1.96 | 1.77 |
| Distribu- | | | | | | |
| tion: | | | | | | |

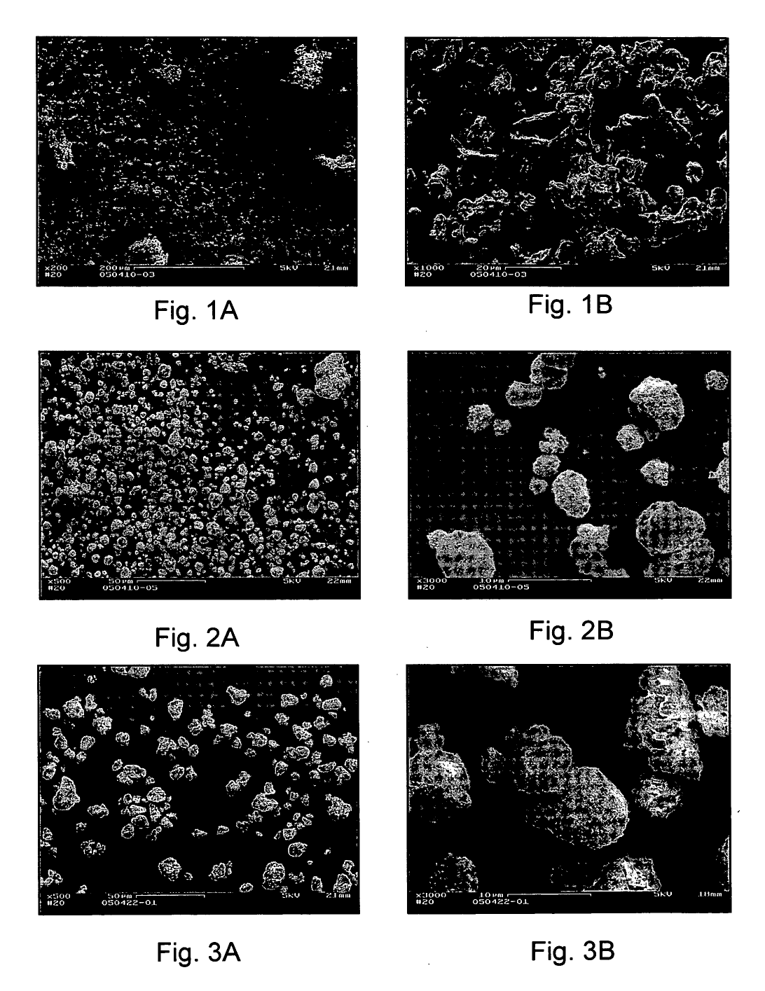

Scanning electron microscopy (SEM) pictures of the PTFE particle compositions show the particle size distributions reflected in Table 2. FIG. 1A and B depict two SEM photographs of the MP 1400 PTFE particles. FIG. 1A depicts the particles at a magnification of 200 and FIG. 1B depicts the particles at a magnification of 1000. As can be seen in FIGS. 1A and B, MP 1400 does not show a spherical morphology, instead showing irregular and somewhat elongated, globular particle shapes.

FIGS. 2A and 1B depict SEM photographs of the MP1600 PTFE composition. FIG. 2A depicts the particles at a magnification of 500 and FIG. 2B depicts the particles at a magnification of 3000. As can be seen, the particle morphology is of substantially spherical, compact particles that do not appear friable (i.e., capable of being broken down into smaller sizes).

FIGS. 3A and B depict SEM photographs of the PA5951 PTFE composition. FIG. 3A depicts the particles at a magnification of 500 and FIG. 3B depicts the particles at a magnification of 3000. As with the particles depicted in FIGS. 2A and B, the particle morphology depicted in FIGS. 3A and B is of substantially spherical, compact particles that do not appear to be friable.

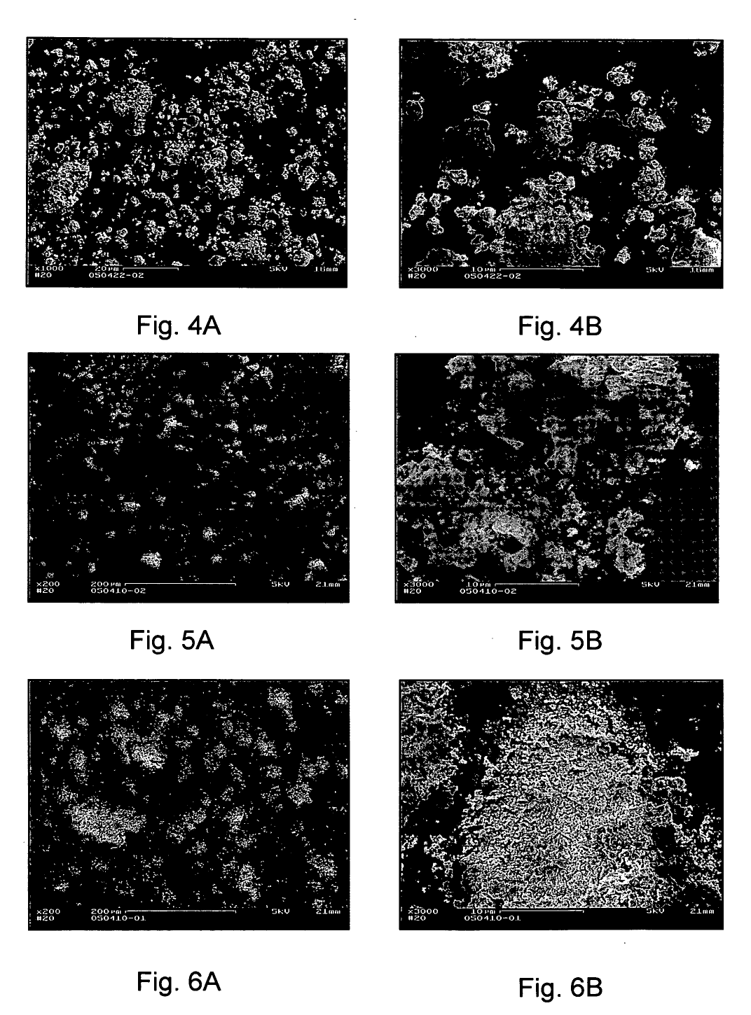

FIGS. 4A and B depict SEM photographs of the PA5955 PTFE composition. FIG. 4A depicts the particles at a magnification of 1000 and FIG. 4B depicts the particles at a magnification of 3000. As can be seen the PA5955 particle composition shows a higher tendency for breakdown of the particles into smaller sizes than can be seen in FIGS. 2 and 3.

FIGS. 5A and B depict SEM photographs of the FluoroFG PTFE composition. FIG. 5A depicts the particles at a magnification of 200 and FIG. 5B depicts the particles at a magnification of 3000. As can be seen, the FluoroFG particle composition shows a higher tendency to breakdown into smaller sizes.

FIGS. 6A and B depict SEM photographs of the Nanoflon P51A PTFE particle composition. FIG. 6A depicts the particles at a magnification of 200 and FIG. 6B depicts the particles at a magnification of 3000. The Nanoflon P51A particles demonstrate a tendency towards agglomeration of small particles rather than the preferred disassociation of particles discussed above. These agglomerations typically have a tendency to breakdown into small particle sizes.

In general terms, the nucleating particles are preferably added to the composition in an amount sufficient to form a large number of very small cells. More specifically, the particles are preferably added in an amount sufficient to form cells having a diameter of no greater than about 150 μm. If an overly large concentration of nucleating agents is added to the composition, the resulting foamed polymer will have low matrix strength and integrity, resulting in a lack of structural integrity in the foam. If the nucleating agent concentration is too low, a low degree of foaming will result, and the resulting foam will contain a small number of large cells. This, too, may result in poor structural integrity of the foamed polymer composition.

A preferred composition includes between about 0.05 and 10 percent by weight nucleating agent, more preferably between about 0.1 and 5 wt %, and most preferably between about 0.5 and 1 wt %.

Alternative inert materials are likewise suitable, with another preferred material being silica particles, particularly silica particles that have been surface treated with PDMS (Poly(dimethylsiloxane) to reduce their surface energy. Silica particles offer certain comparative advantages in that they are available in particles having a largest dimension of no more than about 200 nm and as set forth herein, this can favor the production of a larger number of smaller cells while still obtaining a low density. Zeolites offer certain advantages in that they are available in smaller sizes and include preformed voids.

As noted above, the nucleating agent is chemically inert with respect to the other items in the composition and is added in an amount of between about 0.1 and 10 weight percent. In functional terms, foam produced without a nucleating agent tends to have a relatively coarse pore structure. Including a nucleating agent typically produces much finer foam, with the precise texture depending on the nucleating agent used. The nucleating agent should help, rather than hinder, the production of a uniform foam. The amount used should be sufficient to support the desired cell size and density, but less than an amount whose volume fills an undesirably large proportion of the cells, or that interferes with mixing, extrusion, or the molding processes described later herein.

Without being bound by theory, it is believed that the concentration of nucleating particles and the cell size of the foam are inversely proportional. Stated differently, when the concentration of nucleating agent particles is increased, the cell size of the foamed particles decreases. Similarly, the concentration of the nucleating agent particles and the percent void in the resultant foam are inversely proportional. Cell size and void fraction are, therefore, proportional. Accordingly, those of skill in the art will be able to determine the concentration of nucleating agent particles necessary to form foamed polymers having desired cell size and percent void without undue experimentation.

The incorporation of blowing agents in the composition effectuates foaming. Blowing agents are preferably soluble in the polymer melt and chemically inert with respect to the nucleating agent and the thermoplastic polymer. Preferred blowing agents are introduced to the thermoplastic polymer melt composition under pressure and in liquefied form. At the extrusion temperature of the melt, the blowing agent gas is in a supercritical fluid state since it is above both its critical temperature and critical pressure. Stated differently, preferred blowing agents have a boiling point below the extrusion temperature of the thermoplastic polymer composition. If the boiling point is too low, however, the vapor pressure at the extrusion temperature is too high, resulting in unstable foams due to the loss of structural integrity. Moreover, if the vapor pressure is too high, then the resulting foam suffers from corrugation effects because the extrudate is restricted to expansion in two directions. Rapid gas diffusion at higher vapor pressure may also precipitate foam cell collapse, resulting in higher density.

Blowing agents are preferably added to the extrudate in an amount sufficient to effectuate foaming. Incorporation of too much blowing agent into the composition may result in excessive plasticizing of the polymer composition, as well as reduced viscosity and effective melt strength. The addition of too much blowing agent may result in a substantially lowered melt viscosity of the polymer system resulting in poor foaming performance because a sufficient pressure drop is unavailable. The blowing agent is preferably added in an amount of between about 0.1 and 10% by weight of the thermoplastic resin, more preferably between about 0.5 and 7% by weight of the thermoplastic resin, and most preferably between about 1 and 5% by weight of the thermoplastic resin.

Preferred blowing agents are soluble in the polymer melt. Preferably the blowing agent is present in an amount and of a type that avoids foam instability during extrusion. The blowing agent should demonstrate little or no flammability, for example as compared to agents such as butane or propane. Exemplary blowing agents should have an expansion ratio and escape from the melt at a rate that forms the desired cells while minimizing or preventing foam shrinkage via cell collapse. The agent should be compatible—and preferably inert—with respect to the polymers, their residual catalysts, and the nucleating agent (some blowing agents may react with polymer catalysts).

For thermoplastic polymers of the type disclosed herein, suitable blowing agents include hydrofluorcarbons, fluorocarbons, hydrocarbons, atmospheric gases, chemical blowing agents, and mixtures thereof. Hydrofluorocarbons are especially preferred when perfluorocarbon nucleating agents are utilized due to their affinity to the perfluorocarbon nucleating agents. Preferred hydrofluorcarbon blowing agents include, but are not limited to, HFC-32, HFC-125, HFC-134a, HFC-142a, HFC-143a, HFC-152a, and combinations thereof. Preferred hydrocarbons include, but are not limited to, butane, pentane, cyclopentane, isopentane, n-hexane, n-heptane, isobutane, and combinations thereof. Preferred atmospheric gases include nitrogen, carbon dioxide, and combinations thereof. Chemical blowing agents contemplated as useful in the present invention include azodicarbonamide, 5-phenyl tetrazole, sodium carbonate, and combinations thereof.

A preferred blowing agent comprises 1,1,1,2-tetrafluoroethane, which is also referred to as HFC-134a, and is available under a number of trade names, the most common of which is FREON® 134a. Other designations include SUVA-134a, GENETRON®-134a, FORANE®-134a, and KLEA®-134a. FREON® is a registered trade name for E. I. DuPont. GENETRON® is a registered trade name for Honeywell. FORANE® is a registered trade name for Atofina. KLEA® is a registered trade name for Ineos Fluor. 1,1,1,2-tetrafluoroethane has the chemical formula CH2FCF3 and CAS Registry No. 811-97-2. It is a colorless pressurized liquid with slight ether like odor and has the following physical properties:

| | | | Critical | Critical | | |
|---|---|---|---|---|---|---|
| Mo- | Boiling | | Tempera- | Tempera- | Critical | Critical |
| lecular | Point | Boiling | ture | ture | Pressure | Pressure |
| Mass | ° C. | Point ° F. | ° C. | ° F. | MPa | psia |
| 102.03 | −26.1 | −15.0 | 101.1 | 214.0 | 4.06 | 589 |

In another aspect, the invention is a method of forming a foamed polymer. In this aspect, the invention comprises extruding a composition of a thermoplastic polymer resin including a nucleating agent in an amount of between about 0.05 and 10 percent by weight of the total composition, with the nucleating agent being insoluble in the thermoplastic polymer resin and chemically inert with respect to the thermoplastic polymer resin, and a blowing agent in an amount of between about 0.1 and 10% by weight of the thermoplastic polymer resin. The blowing agent should be soluble in the thermoplastic polymer resin, chemically inert with respect to the base resin and with respect to the nucleating agent and normally in the gaseous state at atmospheric pressure. The blowing agent is preferably soluble in the polymer in order to facilitate uniform distribution in the polymer. In an exemplary embodiment, the extrusion of the composition is carried out at a pressure drop sufficient to form cells at individual particles of the nucleating agent as the composition extrudes. The extruded composition may then be quenched into a foamed solid. In an especially preferred embodiment, the extruded composition may be quenched into a shaped foamed solid.

U.S. Pat. No. 5,912,729 describes typical cell measurement techniques, any of which can be used in accordance with the present invention. These include manual measurement using optical microscopy; manual counting of the number of cells along a fixed length employing optical microscopy; visual comparison with an accepted standard foam utilizing optical microscopy; visual comparison with an optical grid of known dimensions using a microscope; enhancing the foam surface for any of these visualization techniques by coloring, dying, or dusting; measurement after visualization by projecting the image of a thin slice of foam on a screen; indirect diameter calculations via strut length measurements by optical microscope; measurement with the aid of a scanning electron microscopy (SEM) after appropriate sample preparation (i.e., gold coating); and measurement with an optical microscope after enhancement by embedding the foam sample in a plastic resin, curing, cutting, and polishing the specimen.

The '729 patent goes on to describe a measurement technique that incorporates a liquid material suitable for obtaining foam sample impressions in a vessel; placing a foam sample in contact with the material before the impression material hardens, peeling the foam sample from the impression material after the material has begun to harden in order to provide a three-dimensional impression of at least one layer of the foam sample. This produces a plurality of partial quasi-spherical impressions corresponding to cells of the foam sample; after which the cell size can be evaluated by measuring a diameter of a plurality of the quasi-spherical impressions.

The foamed polymer composition according to the invention has a void fraction of at least about 35% by volume and preferably between about 50 and 95% by volume. As a result, a wide variety of shaped articles can be formed from the composition.

The method can further comprise forming a foamed sheet, film or rod/profile from the extrusion, or extrusion blowing, or extrusion blow molding, or injection molding. Indeed, these are exemplary rather than limiting techniques, and the nature of the composition and its structural integrity asides that it can be used in a number of otherwise conventional plastic-forming techniques.

In blown film extrusion molding (also called the inflation method or tubular film extrusion molding) molding is continuously carried out while inflating a tube by blowing a gas at atmospheric pressure or higher inside the tube at the time of extrusion in tube form from the tip of an annular die on an extruder.

The method can produce a shaped article and can include the step of quenching the foamed melt while shaping the extruded foam into the shaped article or shaping the foamed into an article after the foam has solidified.

In typical (but not necessarily limiting) processes, the thermoplastic polymer composition is softened in a heated cylinder and then injected while molten under high pressure into a closed mold. The mold is cooled to induce solidification, and the molded preform is ejected from the mold. Molding compositions are well suited for the production of preforms and subsequent reheat stretch-blow molding of these preforms into the final shapes (bottles are typical for solid PET rather than foam) having the desired properties. The injection molded preform is thereafter heated to suitable orientation temperature, and is then stretch-blow molded. The latter process consists of first stretching the hot preform in the axial direction by mechanical means such as by pushing with a core rod insert followed by blowing high pressure air (up to about 500 psi) to stretch in the hoop direction. In this manner, a biaxially oriented blown bottle is made. For bottles, typical blow-up ratios often range from about 5:1 to about 15:1.

The invention also includes the method of forming the various thermoplastic foams described herein. In this regard, there are a number of controlling factors that produce the desired foams and their given surface and cell size characteristics.

Without being bound by theory, it is believed that near-simultaneous nucleation of a large number of bubbles in the melt, followed by rapid cooling to control the expansion and coalescence of the individual cells enable the extrusion of foams with small uniform cells.

A high density of potential nucleating sites may be necessary to form a high density of bubbles. The seeding of the thermoplastic melt with a high density of well-separated nucleant particles possessing favorable surface characteristics is believed to enable the initiation and growth of gas bubbles when the imposed melt pressure falls below the vapor pressure of the dissolved blowing agents. Favorable particle characteristics include, but are not limited to, poor wetting with respect to the thermoplastic polymer melt and the existence of micro-crevices on the particle surface which can harbor trapped gases.

Near-simultaneous bubble nucleation on all or most of these sites may be enhanced by a rapid decompression of the melt, wherein the imposed pressure falls below the vapor pressure of the dissolved gases within a time scale that is small in relation to the expansion rate of the bubbles. Higher rates of decompression may result in higher bubble nucleation rates. If nucleation is too slow, then the earliest-forming bubbles may grow large before later ones can nucleate, and further nucleation may be inhibited by depletion of the surroundings of dissolved gases that diffuse into the growing bubble.

The growth rate of the bubbles can be very rapid, reaching target sizes within a few milliseconds. The achievement of uniform bubble sizes breaks may be primarily controlled by; 1) slowing the growth rate of the bubbles, once nucleated, and 2) ensuring a fast decompression to generate a large thermodynamic instability of the polymer/gas solution.

The bubble growth rate may be inhibited by viscous resistance or viscoelasticity of the polymer, which is favored by high melt viscosity, and also by elastic forces that develop near the surface of the bubble under rapid strain. These types of forces may be controlled by the nature of the polymer, e.g. structure, molecular weight and degree of branching or cross-linking, as well as by the temperature of the melt. It also may be influenced by the presence of the dissolved gas molecules that plasticize the polymer. Bubble growth rate may also be influenced by the permeability of the gas through the polymer into the growing bubble. As known by those having ordinary skill in the art, permeability is a function of the gas solubility in the polymer and the diffusivity of the gas through the polymer. Diffusion and solubility is determined by the molecular size of the gas, its interaction with the polymer molecules, the concentration of gas in the melt, and the melt temperature. It can be of benefit to include small amounts of highly mobile gases that generate high initial vapor pressure to ensure rapid bubble nucleation, but become depleted before bubbles have become too large.

The decompression of the polymer may occur during the flow of the melt through a die into the atmosphere, during which elongation and shearing of the fluid elements convert the pressure energy into heat. To ensure that this pressure drop occurs rapidly with respect to the bubble growth time, it may be is beneficial to use small, short openings so that the polymer melt experiences very high shear rates for a very brief period of time. Elastic polymer effects may also be beneficial, by generating melt tensions during flow elongation and during shearing flow near the particle interfaces; these elastic tensions may act to counter the pressure forces and thus encourage nucleation.

The percentage of void volume and thus the density reduction generated is typically controlled through the rate at which the blowing agent is added.

An appropriate manner of adding blowing agent is described in U.S. Pat. No. 6,051,174; i.e. by pressurizing the blowing agent (which is typically a gas at room temperature and atmospheric pressure) and then metering it into the extruder containing the polymer (or copolymer melt). Particular techniques or equipment for adding a gas to an extruder can be selected or adjusted by those of ordinary skill in this art and without undue experimentation and thus will not be discussed in detail herein.

As used herein, the term “bubble” is to be understood as including the terms “cell,” or “void.” Those having ordinary skill in the art will recognize that the term “bubble” typically refers to voids in liquid polymers and “cell” typically refers to voids in solid polymers.

The bubble size and frequency (or cell density as cells per unit volume) may also be controlled by controlling the nucleating agent and the extrusion conditions. Although a preferred nucleating agent is a fluorocarbon polymer as previously described herein, other nucleating agents may be used provided that they are incompatible with the polymer. Stated differently, in order to help generate cells the nucleating agent must avoid adhesion to the polymer and must form a second phase when mixed with the polymer. Similarly, the characteristics of the nucleating agent must be such that it avoids otherwise interfering with the extrusion foaming process.

The resulting foams can be produced with either closed cells or open cells, or in some cases both. This can likewise be controlled depending upon the rate of blowing agent addition and the control of the bubble size.

In one embodiment, the invention includes the step of dissolving an inert blowing agent, in an amount sufficient to generate at least about 35% void fraction in the resulting thermoplastic foam, in a liquid thermoplastic to form a solution, rather than a mixture or suspension, of the blowing agent in the thermoplastic. Stated differently, the blowing agent may be soluble in the thermoplastic polymer. Thus, a preferred blowing agent is soluble in the thermoplastic at temperatures at which the thermoplastic is in the liquid state, but does not react chemically with the thermoplastic. Having such characteristics, the blowing agent will evaporate from the thermoplastic polymer at lower temperatures or pressures (or both) and form the desired bubbles and cells. Hydrofluorocarbon blowing agents are commercially available under the SUVA® (E. I. du Pont de Nemours and Company, Wilmington, Del.), GENETRON® (General Chemical Company Corporation, New York, N.Y.), FORANE® (Produits Chimiques Ugine Juhlmann Corporation, Courbevoie, France) or KLEA® (ici Chemicals & Polymers Limited Corporation, Cheshire, United Kingdom) trade names are suitable, with HFC-134a (CF3CH2F) being a presently preferred and commercially available material.

It will thus be understood that the term “inert” as used with respect to the blowing agent defines a material different from those that are considered “inert” as nucleating agents. Those of ordinary skill in this art will recognize the difference and understand the two uses herein according to their context.

The method may also include mixing the inert nucleating agent with the thermoplastic polymer in an amount sufficient to increase the number of cells that the blowing agent will generate as compared to blowing agent alone under the same conditions, but less than an amount that adversely affects the extrusion foaming process. As noted earlier, this is typically no more than about 10 percent by weight.

The method may also include adding the blowing agent to the thermoplastic and the nucleating agent mixture in the liquid state to an extruder while maintaining the blowing agent in the liquid state. The mixture may then be forwarded to a die at high extrusion pressure to give a high pressure drop rate and shear to encourage nucleation of a large number of bubbles by the blowing agent as the thermoplastic leaves the die opening. The method may also include forming the mixture into a foamed article.

In exemplary embodiments, the method may further include quenching the foamed thermoplastic in an otherwise conventional manner. In addition to the other factors described earlier, a higher cooling rate at quenching is believed to produce smaller cells because the solidification of the foam proceeds more quickly.

As noted above, a sufficient pressure may be maintained in the extruder to keep the dissolved blowing agent in solution at the temperature of the liquid thermoplastic polymer solution.

The use of a higher pressure (i.e., higher than would be used to extrude a non-foamed thermoplastic polymer otherwise having the same composition) may provide a greater pressure drop following extrusion and this may encourage the development of a desirable, uniform foam.

The blowing agent is preferably dissolved in an amount of between about 1 and 10% by weight based on the weight of the thermoplastic polymer, and most preferably in an amount of between about 2 and 8% by weight based on the weight of the thermoplastic polymer.

In preferred embodiments, the method may include a master batch technique for mixing the nucleating agent with the thermoplastic polymer. In this embodiment, the method may include preparing a master batch of the nucleating agent and the thermoplastic polymer with the nucleating agent present in a higher proportion than desired for extrusion, and thereafter mixing the master batch with an additional amount of the thermoplastic polymer until the concentration of nucleating agent in the thermoplastic polymer reaches the extrusion amount.

In the exemplary embodiments, the method may also include preparing a master batch of micron-sized particles of fluorocarbon polymer as the nucleating agent with a thermoplastic. The method may also include preparing a master batch that is about 10% by weight of nucleating agent and thereafter mixing 1 part of the master batch with between about 9 and 19 parts of the thermoplastic polymer.

In an alternative aspect of this embodiment, the step of mixing the nucleating agent with the thermoplastic polymer may include mixing a nucleating agent in the solid-state with polymer chips. Thereafter, the polymer chips may be melted for the purpose of the extrusion and blowing agent solution steps. Furthermore, it is believed that the inert nucleating agent can be added to a thermoplastic at the post-polymerization stage.

In another embodiment, the method may include mixing a fluorocarbon polymer nucleating agent with a thermoplastic in an amount of between about 0.5 and 1.0% by weight; dissolving a hydrofluorocarbon blowing agent in its liquid state in the mixture of the thermoplastic and nucleating agent to form a solution of the blowing agent in the thermoplastic-nucleating agent mixture; and extruding the mixture to produce small cells in the resulting foam.

In this embodiment, the method may include extruding the mixture at a higher than normal extrusion pressure (as compared to an unfoamed thermoplastic extrusion) to give extra shear and encourage expansion of the blowing agent as the foam leaves the die.

As in the previous embodiment, the step of mixing the nucleating agent with the thermoplastic can comprise mixing the nucleating agent in the solid-state with polymer chips and thereafter melting the mixture, both prior to the step of dissolving the blowing agent.

In another aspect, the invention is a process for melt extrusion of thermoplastic foam. In this aspect, the invention comprises extruding a molten mixture of an elastic thermoplastic polymer with a melt viscosity of the least about 1000 poise at extrusion temperature and a molecular relaxation time of at least about 0.001 seconds (1 millisecond).

In preferred embodiments the polymer is polyester, including copolymers and blends, with copolymers of polyethylene terephthalate being preferred.

The mixture being extruded may contain an additive including insoluble (with respect to the melt) particles that range in size from between submicron and 20 μm and that are present in an amount of between about 0.1% and 1.0% by weight. The melt may also contain a dissolved blowing agent in an amount sufficient to generate a gas pressure of between about 5 and 200 atmospheres at extrusion temperature, the mixture being extruded through a die at a flow rate sufficient to generate shear rate exceeding about 10,000 per second.

The particles are preferably insoluble with respect to the polymer melt. Particles smaller than about 50 nm are unlikely to initiate or sustain nucleation. Without being bound by theory, it appears that particles larger than about 20 microns (μm) do not produce uniform, small celled foam structures. In general, all other factors being equal, smaller particles are better than larger ones consistent with the above limitations.

In an exemplary embodiment, at least about 0.1% by weight of particles may be required to initiate bubbles. Amounts greater than about 1% by weight may, however, tend to adversely affect the foaming process and the resulting foams.

As used herein with respect to the blowing agent, the term “dissolved” refers to the blowing agent being soluble in the thermoplastic polymer melt.

With respect to the gas pressure, it should be understood that in extrusion equipment and processes, the gas does not always behave consistently with the ideal gas law, but rather is typically under supercritical conditions and often behaves in that manner. The pressure has to be high enough for the gas to leave the melt as the melt enters and then exits the spinneret hole(s). An overly high pressure, however, simply pushes the polymer into pieces without generating small bubbles. The gas pressure also must be lower than the pressure at which the thermoplastic polymer is being extruded. In that regard, those familiar with polyester manufacturing processes will recognize that an extrusion pressure of about 1000 lbs. per square inch (psi) is normal, 3000 psi is relatively high, and 500 psi is relatively low.

Those familiar with variables in polymer production will understand that some variables can typically be proactively controlled while other variables will typically follow from the controlled ones. Accordingly, in carrying out the invention the factors or variables that can be readily controlled include the temperature range, the choice and composition of the polymer, the intrinsic viscosity, the melt viscosity, the extrudate shape and thickness, mass throughput, the type and amount of nucleating agent, and the type and amount of blowing agent.

In turn, the mass throughput typically dictates the pumping pressure, and as noted above, the pressure of the blowing agent should typically exceed the pumping pressure in order to bubble and generate foam.

The gas pressure and pumping pressure are often in equilibrium with each other through the flow path. When the polymer/gas solution reaches a pressure less than that which can keep the gas in solution, the gas starts evolving and bubbles start to form. The goal is to run the process so this starts to happen in the spinneret capillary. Preferably the gas evolution should be at a location where high shear is present so that the nucleating particles can “tear” the polymer creating small openings for the gas to enter. The highest process shear is in the exit capillary of the die.

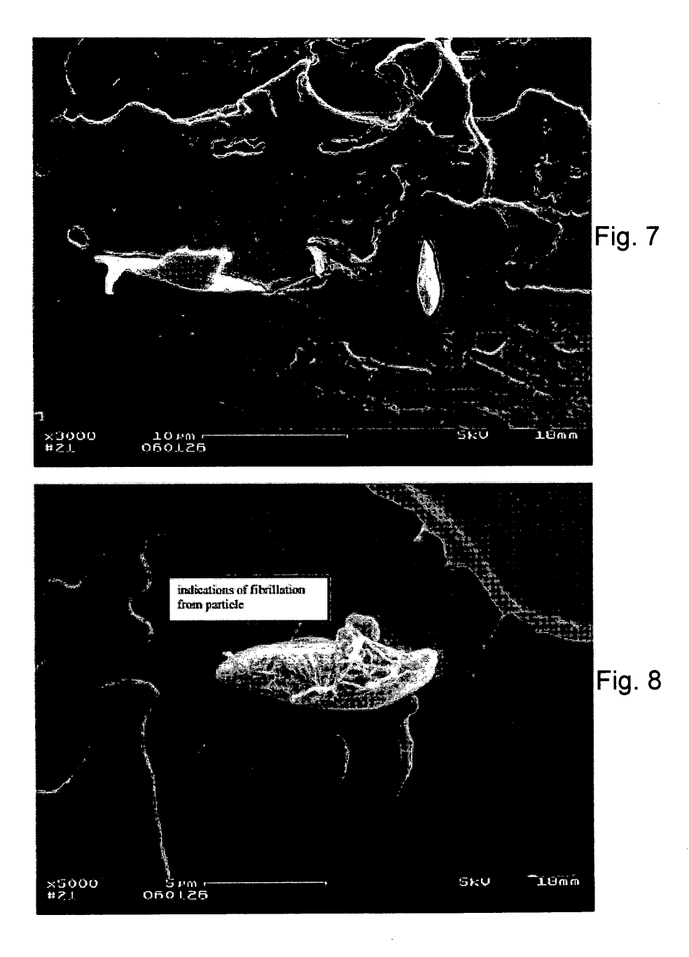

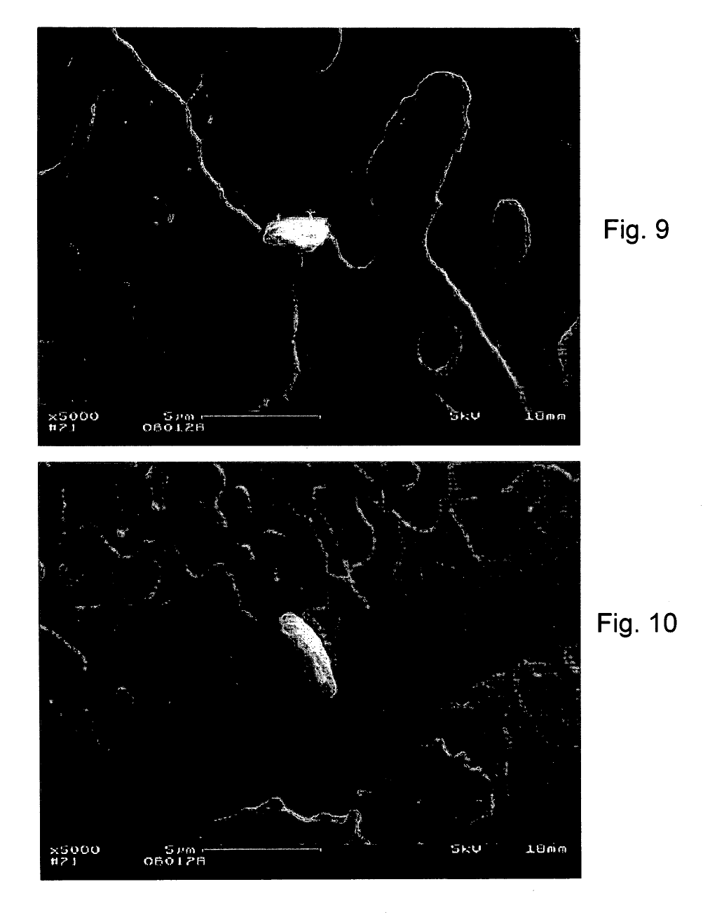

FIGS. 7-14 are SEM photos of polyester terephthalate extrudates including nucleating particles. As can be seen, the nucleating particles tend to exhibit altered morphology as they “tear” the polymer.

Thus, it will be understood that prior to die exit, the polymer is often under the pumping pressure, while at the exit from the die, the polymer is typically at atmospheric pressure. A linear pressure drop exists from the pumping pressure to atmospheric pressure through the die exit. The goal is to avoid generating bubbles at pumping pressure but instead to have bubbles form as the pressure drops from the pumping pressure to the atmospheric pressure as the polymer moves through and exits the die.

It is believed that the ultimate foam density (gas conversion) can be shown to have a dependence of the PTFE concentration used. At a given concentration of dissolved blowing agent, higher PTFE levels lead to higher nucleation rates which in turn lead to smaller cells. If the PTFE concentration is too high, however, ultimate foam density may be detrimentally affected.

### EXAMPLES

PTFE micropowder samples were acquired from three suppliers. Nanoflon P51A & Nanoflon FluoroFG were obtained from Shamrock Technologies, Inc. Zonyl MP1400 and MP1600 were obtained from DuPont. Dyneon, LLC (3M subsidiary) provided samples of PA5951 & PA5955. Each PTFE was compounded as provided into dried bottle grade PET resin at 5 wt % concentration on a Theysohn 21 mm co-rotating twin-screw extruder. Typical PET processing temperatures were used for all compounding at a total throughput of 20 lbs/hr consisting of 1 lb/hr of PTFE powder and 19 lbs/hr of bottle-grade PET as measured by K-tron (loss-in-weight) feeders. These 5 wt % masterbatch concentrates were crystallized and dried, then mixed with additional dried bottle grade PET resin to make 0.25%, 0.50%, 1.0% and 2.0% final PTFE levels prior to feeding the mixture for foamed sheet extrusion.

Foamed PET sheet extrusion trials were carried out on a Killion 1.5″ single-screw extruder (L/D=30). Extrusion foaming temperature profiles were held constant across all trials. A modified barrier screw was used with a “pineapple” mixing head for uniform distribution of physical blowing agent within the polymer melt prior to extrusion through a standard “coat hanger” flat sheet die. The die was equipped with a 1/16″ wide land just prior to the die lip to maximize the pressure drop rate of the gas-laden melt upon extrusion and improve foaming performance. The physical blowing agent used to make all foam samples was HFC-134a (1,1,1,2-tetrafluoroethane) obtained from Honeywell under the Genetron trade name. The HFC-134a was added at a concentration of 4 wt %.

Particle size distributions for each of the PTFE micropowders were measured using a laser light diffraction method by Particle Technology Labs, Ltd. in Downers Grove, Ill. A Malvern Mastersizer S LASER diffractor was used for all measurements, which determined particle size in terms of equivalent spherical diameter (microns). Each sample was dispersed in a light mineral oil and sonicated to break up large agglomerates prior to analysis. Photomicrographs of each PTFE sample were taken to visually compare the PTFE particle morphologies (FIGS. 1A through 6B).

Machine and transverse direction cross-sections of foam sheet samples were imaged by electron microscopy and the images analyzed for void fraction and cell size. Densities of the foams were calculated from the sample average void fraction (vf) results based on machine and transverse cross-sectional data. Foam density=(1-vf)*1.334, where 1.334 is the density of unfoamed PET. Cell densities (the number of cells per cubic centimeter of foam) were calculated according to the method of Moulinie' et. al., Low Density Foaming of Poly(ethylene-co-octene) by Injection Molding, SPE ANTEC Proceedings, 2, 1862 (2000).

Holding the blowing agent and PTFE concentrations constant, differences in the density and nucleation of PET foams made form the different PTFE micropowders were discernible. PA5951 and PA5955, as well as MP1600 resulted in a preferred combination of small cell sizes while yielding the lowest foam densities. A high cell density allowed for small cell sizes, arising from a high nucleation efficiency or rate. Without being bound by theory, it appears that gas conversion is related to the efficiency to nucleate and grow bubbles resulting in the most density reduction in the final foam at a given amount of dissolved blowing agent. Higher gas conversions translate to lower foam densities, which were observed using the Dyneon PA5951 & PA5955 materials and the DuPont Zonyl MP1600 material. With respect to the FluoroFG and P51A materials, they demonstrated closely related cell nucleation performance, but the P51A demonstrated poorer gas conversion.

Table 3 demonstrates the performance comparison in nucleation and gas conversion cell density vs. foam density with 4% blowing agent.

TABLE 3

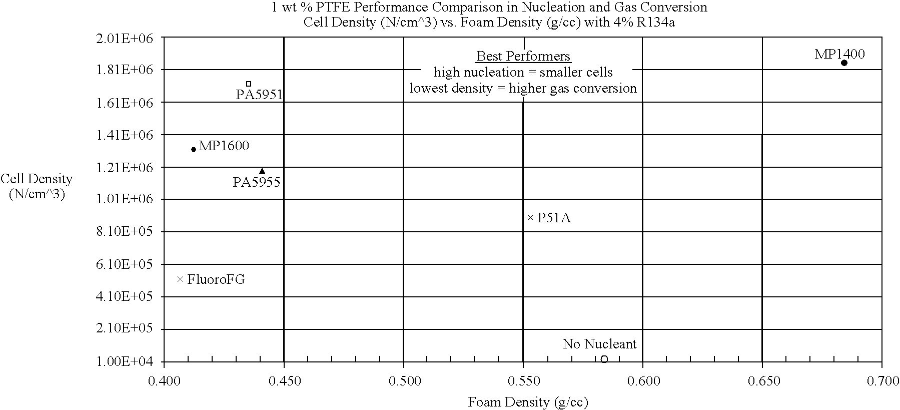

An ancillary benefit to the foaming process has been observed from the use of PTFE micropowder nucleant. As seen in FIG. 15, the melt viscosity of the thermoplastic (PET) is substantially increased.

An increase in the melt viscosity of the thermoplastic to be foamed may translate to an increased pressure drop across the foaming die thereby resulting in improved foam cell nucleation density. Increases in cell nucleation typically promote the formation of a greater number of smaller cells, which is desirable from a foam physical properties standpoint.

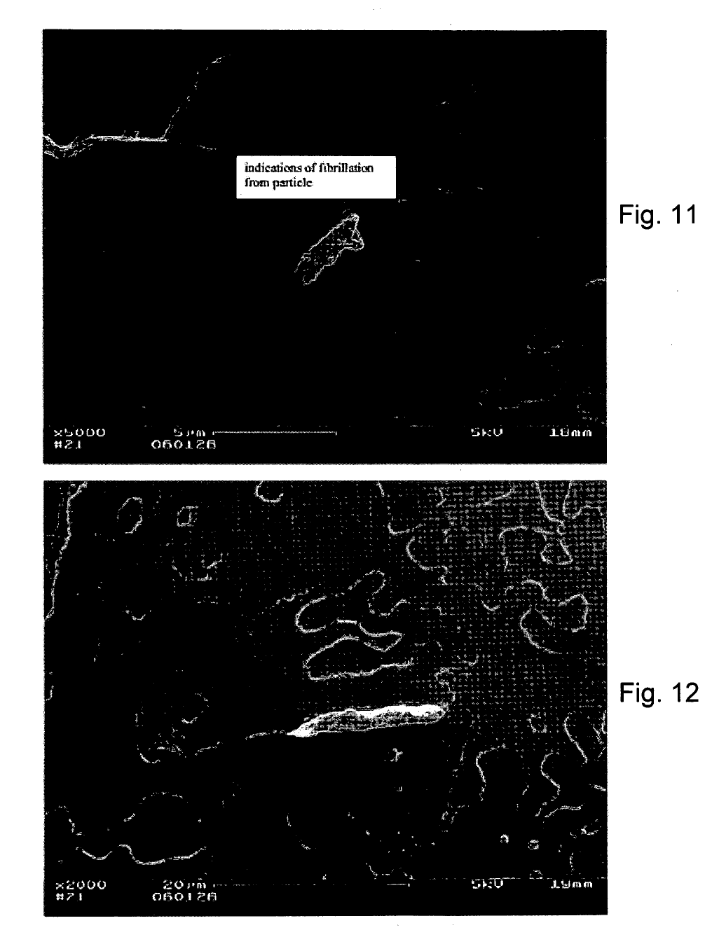

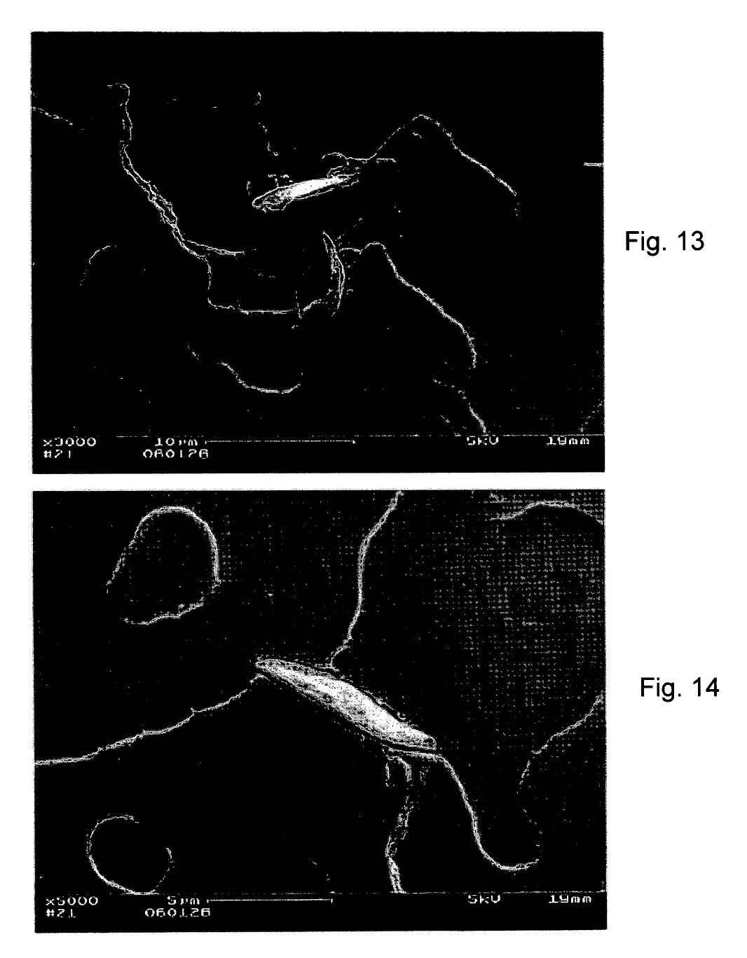

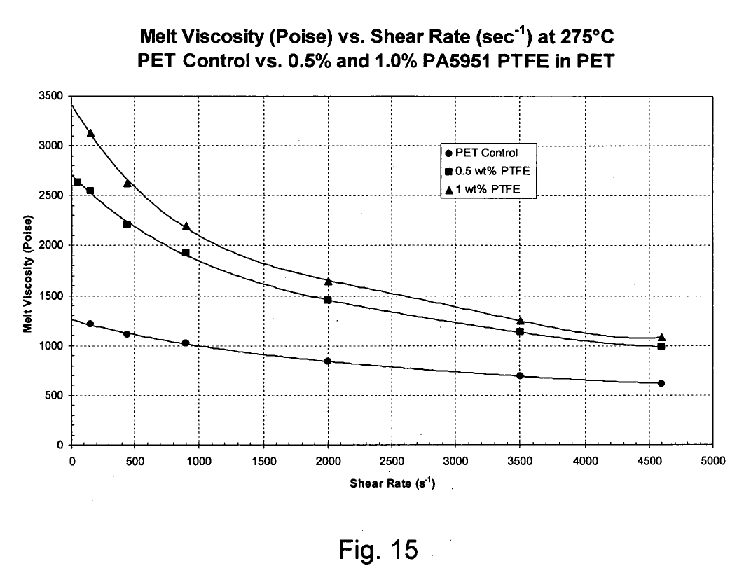

Without being bound by theory, it is believed that the mechanism for the increased melt viscosity is due to the formation of a microfibrillar morphology within the PTFE nucleant particles upon exposure to the shearing effects of compounding or extrusion. FIGS. 8 and 11 show SEM micrographs of PET extrudate containing PTFE nucleant and indicate a flattening or elongation of the particles has occurred relative to their neat, spherical-like particle morphologies as received. Furthermore, indications of microfibrillation from some of the PTFE particles can be readily seen in FIGS. 8 and 11. It is believed that the presence of these fibrillations from the PTFE particles create additional surface area and opportunities for chain entanglement at the PTFE-PET interface leading to the observed increases in melt viscosity.

Supporting evidence for the tendency of PTFE to form microfibrillar morphologies can be found in the literature. For example, U.S. Pat. No. 5,141,522 discloses a composition for a composite material made of a bioabsorbable polymer and microfibrillar PTFE. The microfibrillar PTFE morphology is formed by extrusion processing of a thermoplastic polymer containing PTFE micropowder comparable to those disclosed in this invention. It is noted that the formation of the microfibrillar PTFE typically occurs below the sintering temperature of PTFE, which is about 327° C. The foamable thermoplastic processing disclosed in the invention also typically occur at temperatures considerably lower than the PTFE sintering temperature.

Extreme examples of tendency for formation of a network of microfibrillar morphology within PTFE can be found in J. Phys. D: Appl. Phys. 22 (1989), 1877-1882. Micrographs of microfibrillation with expanded PTFE are shown in the paper. Numerous microfibrils of PTFE can be readily seen between clusters of anisotropic, dispersed PTFE particles within the expanded PTFE matrix. While the fibrillation of PTFE in the present invention has not been observed to the degree of exhibiting an extended network between dispersed PTFE particles within the foamable thermoplastic matrix, the presence of fibrillation from individual PTFE particles that have been observed is believed to be adequate to account for the increased melt viscosity.

In the drawings and specification there has been set forth a preferred embodiment of the invention, and although specific terms have been employed, they are used in a generic and descriptive sense only and not for purposes of limitation, the scope of the invention being defined in the claims.

1. A foamable thermoplastic polymer melt comprising:
a thermoplastic polymer;
a nucleating agent composition present in an amount sufficient to form a large number of very small cells and chemically inert with respect to the thermoplastic polymer; and
a blowing agent that is soluble in the polymer melt and present in an amount sufficient to generate foam but less than an amount that would excessively plasticize the polymer composition, and inert with respect to the thermoplastic polymer and the nucleating agent.

2. A polymer melt according to claim 1 wherein said nucleating agent forms cells having a diameter of no greater than about 150 μm.

3. A polymer melt according to claim 1 wherein said thermoplastic polymer is selected from one or more of polyesters, aliphatic polyesters, polylacides, polyamides, polycarbonates, polyolefins, polyacrylics, polystyrenes, styrenic copolymers, and polyvinylchloride.

4. A polymer melt according to claim 3 wherein said polyesters are selected from one or more of thermoplastic polyesters having diacid or dimethyl ester components.

5. A polymer melt according to claim 4 wherein said diacid or dimethyl ester components are selected from one or more of terephthalic acid, isophthalic acid, naphthalene dicarboxylic acid, biphenyldicarboxylic acid, biphenyldicarboxylic acid, C₄-C₁₀ aliphatic dicarboxylic acid, and spiroacetal diacid or dimethyl compounds

6. A polymer melt according to claim 3 wherein said polyesters are selected from one or more of thermoplastic polyesters having diol components.

7. A polymer melt according to claim 6 wherein said diol components are one or more of ethylene glycol, diethylene glycol, 1,2-cyclohexanedimethanol, 1,3-cyclohexanedimethanol, 1,4-cyclohexanedimethanol, 1,3-propanediol, 2-methyl-1,3-propanediol, 1,4-butanediol, neopentyl glycol, 1,6-hexanediol, isosorbide, spirocatal compounds including diol groups, polyalkylene oxides selected from polyethylene oxide, polypropylene oxide, ethylene oxide-propylene oxide copolymers, and polytetamethylene glycol.

8. A polymer melt according to claim 1 wherein said thermoplastic polymer is branched.

9. A polymer melt according to claim 1 wherein said thermoplastic polymer is unbranched.

10. A polymer melt according to claim 1 further comprising at least one monomeric branching agent.

11. A polymer melt according to claim 1 further comprising at least one polymeric branching agent.

12. A polymer melt according to claim 1 wherein said nucleating agent composition includes at least about 80% nucleating agent particles having a diameter of between about 3 and 20 μm.

13. A polymer melt according to claim 1 wherein said nucleating agent composition comprises perflurocarbon microparticles.

14. A polymer melt according to claim 13 wherein said perflurocarbon microparticles comprise polytetrafluoroethylene microparticles.

15. A polymer melt according to claim 1 wherein said nucleating agent particles have a diameter, as measured at the largest dimension, of no more than about 900 nm.

16. A polymer melt according to claim 1 wherein said nucleating agent particles have a diameter, as measured at the largest dimension, of no more than about 20 μm.

17. A polymer melt according to claim 1 comprising a copolymer melt composition that includes at least about 80 percent by weight of a thermoplastic resin;

18. A polymer melt according to claim 1 wherein said blowing agent is present in an amount of between about 0.1 and 10 weight percent.

19. A polymer melt according to claim 1 wherein said blowing agent is present in an amount of between about 0.5 and 7 weight percent.

20. A polymer melt according to claim 1 wherein said blowing agent is present in an amount of between about 1 and 5 weight percent.

21. A polymer melt according to claim 1 wherein said blowing agent is a gas in the supercritical state at the extrusion temperature of the melt, the blowing agent gas is in a supercritical fluid state since it is above both its critical temperature and critical pressure. Stated differently, preferred blowing agents have a boiling point below the extrusion temperature of the thermoplastic polymer composition.

22. A polymer melt according to claim 1 wherein said blowing agent is selected from the group consisting of hydrofluorcarbons, fluorocarbons, hydrocarbons, atmospheric gases, chemical blowing agents, and mixtures thereof.

23. A polymer melt according to claim 1 wherein said blowing agent is selected from the group consisting of butane, pentane, cyclopentane, isopentane, n-hexane, n-heptane, isobutane, and combinations thereof.

24. A polymer melt according to claim 1 wherein said blowing agent is selected from the group consisting of nitrogen, carbon dioxide, and combinations thereof.

25. A polymer melt according to claim 1 wherein said blowing agent is selected from the group consisting of azodicarbonamide, 5-phenyl tetrazole, sodium carbonate, and combinations thereof.

26. A method of forming a foamed polymer, the method comprising:
extruding a molten thermoplastic polymer containing an inert nucleating agent at or above the melt temperature of the thermoplastic polymer, and
injecting a blowing agent into the extruded melt.

27. A method of forming a foamed thermoplastic polymer comprising extruding a molten thermoplastic polymer blend in the presence of a blowing agent and fluorocarbon particles that are no larger than micro-sized.

28. A method according to claim 27 comprising extruding a molten thermoplastic polymer in the presence of a blowing agent and nano-sized fluorocarbon particles.

29. A method of forming a polymer that favorably forms foamed shaped items, the method comprising:
extruding a composition of a thermoplastic resin, a nucleating agent in an amount of between about 0.1 and 10 percent by weight of the composition and being insoluble and chemically inert with respect to the thermoplastic resin, and a blowing agent in an amount of no more than about 10% by weight, the blowing agent being soluble in the thermoplastic resin, chemically inert with respect to the thermoplastic polymer and the nucleating agent, and normally in the gaseous state at atmospheric pressure; and
while carrying out the extrusion at a pressure drop sufficient to form cells on individual particles of the nucleating agent as the composition extrudes.

30. A method according to claim 29 comprising quenching the extruded foamed melt composition into a solid.

31. A method according to claim 29 comprising mixing the nucleating agent with the thermoplastic resin and thereafter dissolving the blowing agent in the thermoplastic resin.

32. A method according to claim 31 comprising mixing the nucleating agent in the solid-state with polymer chips and thereafter melting the mixture, both prior to the step of dissolving the blowing agent.

33. A method according to claim 29 comprising extruding a molten mixture of an elastic thermoplastic polymer with a melt viscosity of at least about 1000 poise at extrusion temperature and a molecular relaxation time of at least about 0.001 seconds (1 millisecond).

34. A foamed polymer composition comprising:
at least about 90 percent by weight of a thermoplastic polymer blend,
between about 0.1 and 10% by weight of a nucleating agent, and
at least about 0.05% of a blowing agent.

35. A foamed polymer composition according to claim 34 that has a void fraction of at least about 35% by volume and preferably between about 50 and 95% by volume.

36. A foamed polymer composition according to claim 34 comprising closed cells.

37. A foamed polymer composition according to claim 34 comprising open cells.

38. A foamed polymer composition according to claim 34 comprising open and closed cells.

39. A method of forming shaped foamed items, the method comprising:
extruding a composition of a thermoplastic resin, a nucleating agent in an amount of between about 0.1 and 10 percent by weight of the composition and being insoluble and chemically inert with respect to the thermoplastic resin, and a blowing agent in an amount of no more than about 10% by weight, the blowing agent being soluble in the thermoplastic resin, chemically inert with respect to the thermoplastic polymer and the nucleating agent, and normally in the gaseous state at atmospheric pressure;
while carrying out the extrusion at a pressure drop sufficient to form cells on individual particles of the nucleating agent as the composition extrudes; and
solidifying the resulting foam.

40. A method according to claim 39 comprising a shaping step selected from the group consisting of extrusion blowing, extrusion blow molding, and injection molding.

41. A method according to claim 39 comprising continuously inflating a tube by blowing a gas at atmospheric pressure or higher inside the tube at the time of extrusion in tube form from the tip of an annular die on an extruder.

42. A method according to claim 39 comprising quenching the foamed melt while shaping the extruded foam into the shaped article.

43. A method according to claim 39 comprising or shaping the foamed into an article after the foam has solidified.

44. A method according to claim 39 comprising extruding a thermoplastic resin selected from the group consisting of polyesters, aliphatic polyesters, polylacides, polyamides, polycarbonates, polyolefins, polyacrylics, polystyrenes, styrenic copolymers, and polyvinylchloride and combinations thereof.

45. A method according to claim 39 comprising extruding A polymer melt according to claim 2 wherein said polyesters are selected from one or more of thermoplastic polyesters having diacid or dimethyl ester components.

46. A method according to claim 45 comprising extruding diacid or dimethyl ester components selected from the group consisting of terephthalic acid, isophthalic acid, naphthalene dicarboxylic acid, biphenyldicarboxylic acid, biphenyldicarboxylic acid, C₄-C₁₀ aliphatic dicarboxylic acid, and spiroacetal diacid or dimethyl compounds

47. A method according to claim 39 comprising extruding polyesters are selected from one or more of thermoplastic polyesters having diol components.

48. A method according to claim 47 comprising extruding diol components selected from the group consisting of one or more of ethylene glycol, diethylene glycol, 1,2-cyclohexanedimethanol, 1,3-cyclohexanedimethanol, 1,4-cyclohexanedimethanol, 1,3-propanediol, 2-methyl-1,3-propanediol,1,4-butanediol, neopentyl glycol, 1,6-hexanediol, isosorbide, spirocatal compounds including diol groups, polyalkylene oxides selected from polyethylene oxide, polypropylene oxide, ethylene oxide-propylene oxide copolymers, and polytetramethylene glycol.
